(19) United States
(12) Patent Application Publication
(10) Pub. No.: US 2013/0076698 A1
(43) Pub. Date: Mar. 28, 2013

(54) TYPING AND TEXTING TIPS TO AIDE IN TYPING ON TOUCH SCREEN KEYS OF ELECTRONIC DEVICES

(71) Applicant: Cecilia Palacio, San Diego, CA (US)

(72) Inventor: Cecilia Palacio, San Diego, CA (US)

(21) Appl. No.: 13/245,785

(22) Filed: Sep. 26, 2011

(51) Int. Cl. G06F 3/02

(52) U.S. Cl. 345/179

(57) ABSTRACT

A typing device comprised of a circular band at any width, density and size, to include an extension at any width, shape, length and density, which extends parallel to the finger(s) when worn, with a conductive tip at the end of the extension. Said typing tip is used to aide for more precise typing on touch screen electronic devices when pressing or tapping tip of the device against the screen keys. The typing device can be used for touch screen cell phones, touch screen tablet computers, and without limitations to other touch screen electronic devices.

### FIELD OF THE INVENTION

The present invention relates to a band device to be worn on the thumbs as well as the fingers to interface with touch screen computer electronic devices such as the hand held cell phone, tablet computers and many other touch screen electronic devices.

### BACKGROUND OF THE INVENTION

Electronic devices such as cell phones and tablet computers with touch screen navigation buttons have become smaller, making it difficult to accurately type with one's own thumbs and finger tips, due to the small and narrow contact point of the touch keys. These small navigation buttons are so closely together, that they cause finger tips to periodically hit more than one key at a time, causing the misspelling words in the body of the message. This becomes a constant frustration to the individual in having to go back and correct the misspelling of the word(s), or mistakenly sending a misspelled message to the recipient. This may cause an embarrassing situation to the sender of the message. Many individuals may avoid switching to these types of touch screen devices due to this being problematic.

The typing device hereof invented is designed in such a way that enables a smaller contact point than the finger tip, for a more precise touch of the buttons to the electronic touch screen device keys, which may reduce typing errors and may speed up the typing process. The invention is a circular band utility that has an extending narrow prong with a conductive tip which comes in contact with the electronic key. It can be used on a variety of electronic touch screen devices to aide in the accuracy of typing and texting.

### SUMMARY OF THE INVENTION

The present invention aims to solve at least one of the problems with electronic touch screen navigation keys such as cell phones and tablet computers with small and narrow touch keys. The invention aids in avoiding fingertips from hitting more than one key at a time. The invention is a typing device that can be worn on thumbs and fingers, to aide in reducing typing errors. The invention is a circular shape band with an extension that is parallel to the fingers when worn. The band extension has a small conductive tip that works on most electronic touch screen navigation devices such as cell phones and tablet computers, without limitations to other electronic touch screen devices. This device is both effective for individuals with short or long fingernails, as the ring is worn on the finger with the extension laying parallel underneath the finger. This allows the conductive tip at the end of the extension to come in contact with the touch screen keys first, upon tapping the individual keys with the tip of the device. This typing device can be considered a typing tip or texting tip for touch screen electronic navigation devices, and may substitute in typing with one's own finger tips for better accuracy.

### BRIEF DESCRIPTION OF THE DRAWINGS

FIG. 1 is a top view of the typing device shown with an open circular band that can be adjusted to fit closer to finger by squeezing the band together once fitted.

FIG. 2 is a top view of the typing device showing a closed circular band as another option.

FIG. 3 is a view of the typing device installed on the thumbs of the hands for use in texting.

FIG. 4 is a view of the back of the left hand with the typing device's worn on each finger, showing the top of the band with the extension running parallel underneath the finger, with the conductive tip attached.

FIG. 5 is a view of the palm of the left hand with the typing device's worn on each finger. It shows the view of the bottom of the band, the extension, and the conductive tip.

### DETAILED DESCRIPTION OF THE INVENTION

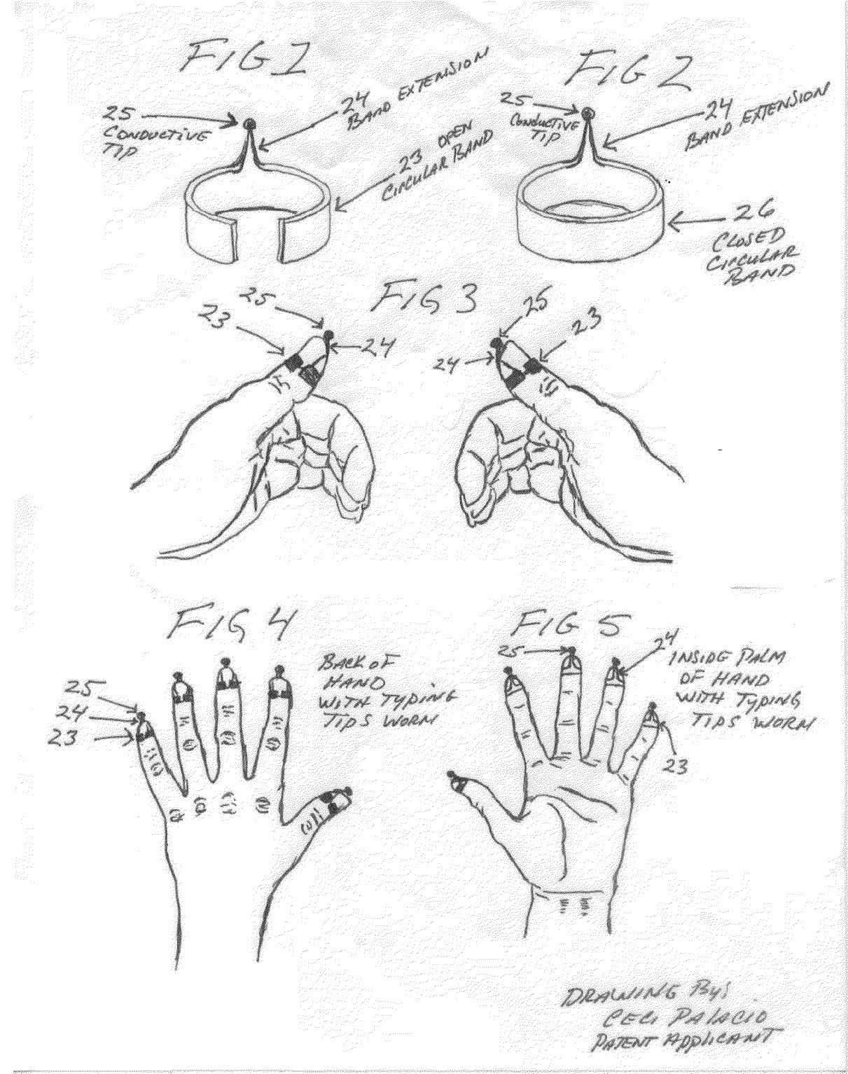

FIG. 1 illustrates a top view of the typing device. The circular band 23 and the band extension 24 can be made of aluminum, copper, stainless steel, gold, silver, plastic, acrylic, rubber or wood, without limitations to a particular metal or material. The circular band 23 and extension 24 can be of any width, density, size or color, and can be smooth, rough, flexible or rigid, and costume design, without limitations. The circular band 23 is open to allow adjustment to the thumb or finger for a more precise fit, as it can be made of soft metal to allow bending and forming around the individual's fingers for a comfortable and snug fit. The circular band can come in different sizes to accommodate the individual's fingers. The extension 24 can be manufactured at any length to accommodate typing precision on the touch screen individual keys. The extension can be any shape without limitations. The conductive tip 25 can be made of conductive foam, and any other type of conductive material without limitations, that will allow contact with touch screen keys to function properly. The conductive tip 25, sits at the end of the extension, and can be manufactured separately and then attached permanently to the extension before sale. The conductive tip can be any size and shape, to allow precise contact with various sizes of electronic touch screen key devices. The circular band in FIG. 1 can be placed on thumbs or index fingers for cell phone touch screen texting, as well as placed on all ten fingers for typing on touch screen electronic devices such as tablet computers, without limitations to such.

FIG. 2 illustrates a top view of the typing device with a closed band 26, rather than an open band as in FIG. 1, 23, and can be made of aluminum, copper, stainless steel, gold, silver, plastic, acrylic, rubber, elastic or wood, without limitations to a particular metal or material. The band 26 and extension 24 can be of any width, density, size or color, and can be smooth, rough, flexible or rigid, and costume design, without limitations. The extension 24 can be of any shape without limitations. The closed band may come in different ring finger sizes to accommodate the individual's fingers and thumbs. The extension 24 and conductive tip 25 are the same descriptions as stated in FIG. 1 above in the “Detailed Description”.

FIG. 3 illustrates the typing device from FIG. 1 placed on the left and right thumbs of the hand. This allows the user to text on touch screen cell phones while holding the phone with the other fingers and hand. The conductive tip 25 of the device is pressed or tapped on the individual keys of the touch screen cell phone, to aide in the contact point between the conductive tip 25, and small individual keys of the cell phone. Closed band FIG. 2 may also be used for texting using the proper size band to accommodate the individual's thumb or finger sizes.

FIG. 4 is a drawing of the back of the left hand, which illustrates how the typing device from FIG. 1 is applied to all fingers. The drawing also illustrates the top view of the typing device showing the band 23, the end of the extension 24 laying parallel underneath the fingers, and the conductive tip 25. The typing device can be applied to all ten fingers to allow the user a more precise contact with the electronic touch screen keys of a computer such as a tablet computer, but not limited to such electronic device.

FIG. 5 is a drawing of the left palm of the hand, which illustrates how the typing device from FIG. 1 is applied to all fingers. The drawing also illustrates the bottom view of the typing device, showing the band 23, the extension 24, and the conductive tip 25. The typing device can be applied to all ten fingers to allow the user a more precise contact with the electronic touch screen keys of a computer such as a tablet computer, but not limited to such electronic device.

### Operation of Typing Tips

The typing tip band is placed around the fingers, allowing the conductive tip to be positioned at the end of the finger tip(s), and at a comfortable extension level for the individuals typing comfort. The conductive tip is then gently pressed or tapped on the individual keys of the electronic touch screen device when typing. The small conductive tip helps in decreasing errors of hitting more than one key at a time. This is often the frustration with individuals using their own fingertips as they are larger than some touch screen key devices. These typing tips will allow a generation of people to switch over to touch screen devices. Many such people have been avoiding these devices due to the small keys in contrast to the large surface area of the finger. The typing tips will greatly help those individuals with long finger nails.

What I claim is;

1. A typing device comprised of a circular open or closed band with an extension of any width, shape or length, which extends parallel to the fingers when worn having a conductive tip at the end of the extension. Said tip is used for precise typing on touch screen electronic devices when pressing or tapping the tip against the touch screen keys.

2. The typing device of claim 1 is used to interface with electronic touch screen devices such as cell phones, tablet computers, and without limitations to other electronic touch screen devices.

3. The device of claim 1 wherein the circular band can be partially open to leave a space for a proper fitting adjustment on the finger by squeezing the band together to one's finger, and can be available in different sizes.

4. The device of claim 1 wherein the material of the circular band and extension can be made from any material to include metals, aluminum, copper, stainless steel, gold, silver, but not limited to such materials. The circular band can be made from any plastic, rubber, acrylic and wood, but not limited to such materials.

5. The device of claim 1 wherein the circular band and extension can be formed and designed with a smooth or rough surface, can be rigid or flexible, can be any color, and can be of costume design such as having “Bling”, without limitations to such as these.

6. The extension of the device of claim 1 can have the conductive tip attached to the end of the extension or can be without the conductive tip and purchased separately.

7. The device of claim 1 can comprise of a single device for the individual thumb or finger, can comprise of a pair of devices for wearing on opposite thumbs or fingers, and can comprise of several devices to wear on all ten fingers, to aide in typing on touch screen keys of electronic devices.

8. The circular band of claim 1 where the inside circumference of the band can have small rounded beads formed of any material, for preventing the band from sliding and moving on the finger while in use for typing and texting.
